(19) United States
(12) Patent Application Publication
(10) Pub. No.: US 2016/0239070 A1
(43) Pub. Date: Aug. 18, 2016

(54) SEMICONDUCTOR DEVICE AND WIRELESS POWER FEEDING SYSTEM

(71) Applicant: KABUSHIKI KAISHA TOSHIBA, Tokyo (JP)

(72) Inventor: Junjiro Oto, Yokohama Kanagawa (JP)

(21) Appl. No.: 14/840,579

(22) Filed: Aug. 31, 2015

(30) Foreign Application Priority Data
Feb. 18, 2015 (JP) 2015-029904

(51) Int. Cl. G06F 1/32; G06F 1/26

(52) U.S. Cl. CPC G06F 1/3212; G06F 1/266

(57) ABSTRACT

A semiconductor device in an embodiment includes an arithmetic unit and a determining unit. The arithmetic unit detects an output current outputted to a charging target device or calculates output power outputted to the charging target device. The determining unit determines, according to the output current or the output power, whether a battery of the charging target device is fully charged.

### CROSS REFERENCE TO RELATED APPLICATION

This application is based upon and claims the benefit of priority from the prior Japanese Patent Application No. 2015-29904 filed on Feb. 18, 2015; the entire contents of which are incorporated herein by reference.

### FIELD

The present invention herein relates generally to a semiconductor device and a wireless power feeding system.

### BACKGROUND

A rechargeable battery has been mounted on a portable terminal such as a cellular phone or a smart phone. When charging the battery of the portable terminal, a user needs to connect one end of a charging device to a commercial power supply and connect a terminal provided at the other end of the charging device to the portable terminal. Such operation is annoying.

Therefore, in recent years, a wireless power feeding technique has started to be used. For example, it is possible to feed electric power to a portable terminal incorporating a wireless power feeding and receiving function simply by placing the portable terminal on a wireless power feeding transmitter.

In such wireless power feeding, after the power feeding is started, a host or a charging control circuit provided in the portable terminal determines whether a battery of a charging target device (the portable terminal) is fully charged. Thereafter, when the host or the charging control circuit determines that the battery is fully charged, the portable terminal transmits a signal indicating the full charge to a power transmitter and stops the power feeding. However, when the signal indicating the full charge is not transmitted from the host or the charging control circuit, the power transmitter cannot determine whether the battery of the charging target device is fully charged.

In this way, there has been a problem that, when the signal indicating the full charge cannot be transmitted, the portable terminal cannot request the power transmitter to stop the power feeding, the power feeding is continued even in a full charge state, and useless electric power is consumed.

### BRIEF DESCRIPTION OF THE DRAWINGS

FIG. 1 is a diagram showing a configuration of a wireless power feeding system including a semiconductor device according to an embodiment;

FIG. 2 is a diagram showing a detailed circuit configuration of the wireless power feeding system including the semiconductor device according to the embodiment;

FIG. 3 is a diagram for explaining an example of a charging characteristic of a charging control circuit 11; and

FIG. 4 is a flowchart for explaining an example of a flow of detection processing for full charge of a power receiving IC 5.

### DETAILED DESCRIPTION

A semiconductor device in an embodiment includes an arithmetic unit and a determining unit. The arithmetic unit detects an output current outputted to a charging target device or calculates output power outputted to the charging target device. The determining unit determines, according to the output current or the output power, whether a battery of the charging target device is fully charged.

The embodiment is explained in detail with reference to the drawings.

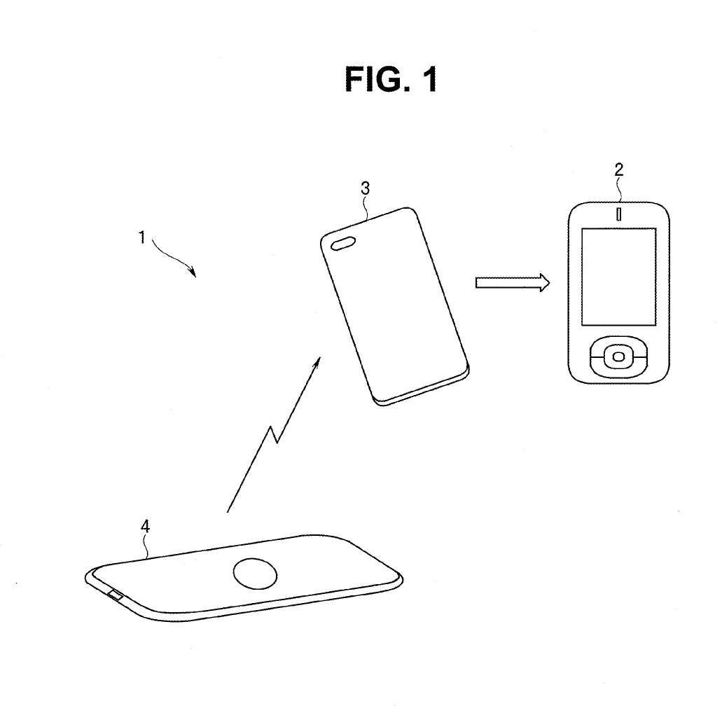

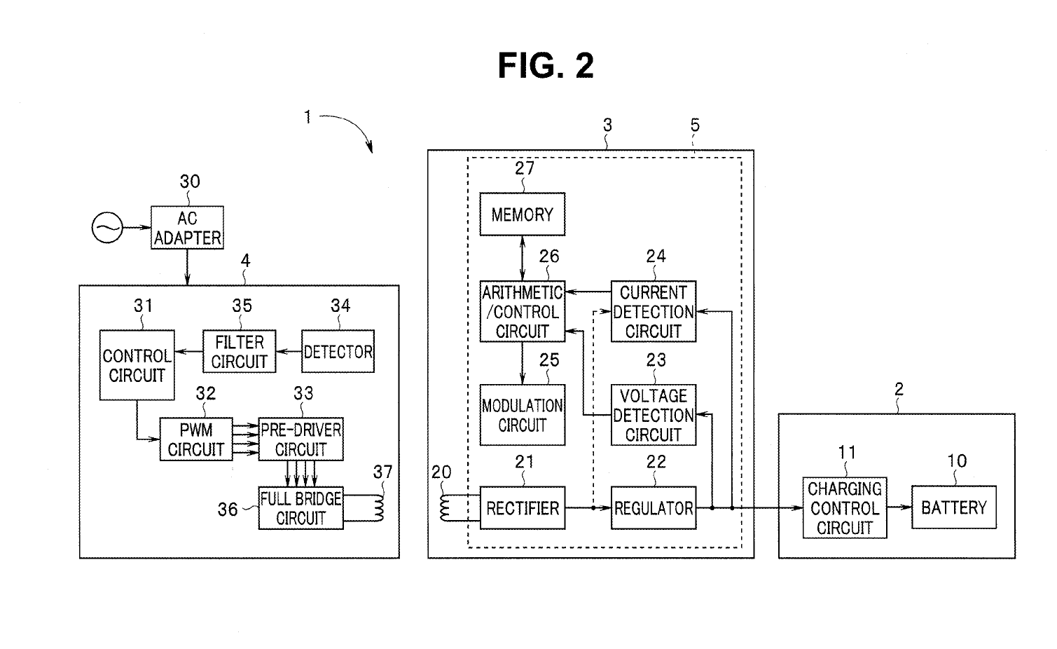

First, a configuration concerning a wireless power feeding system according to the embodiment is explained with reference to FIGS. 1 and 2. Note that, concerning the configuration in the embodiment, a part of functions related to the wireless power feeding system is extracted and explained.

FIG. 1 is a diagram showing the configuration of the wireless power feeding system including the semiconductor device according to the embodiment. FIG. 2 is a diagram showing a detailed circuit configuration of the wireless power feeding system including the semiconductor device according to the embodiment.

A wireless power feeding system 1 in the embodiment includes a portable terminal 2 such as a cellular phone or a smart phone, a portable cover accessory 3 having a wireless power receiving function attachable to the portable terminal 2, and a power transmitter 4 having a wireless power transmitting function and capable of transmitting electric power to the portable cover accessory 3. When the portable cover accessory 3 is attached to the portable terminal 2 and power transmission (power feeding) from the power transmitter 4 is started, electric power received by the portable cover accessory 3 is supplied to the portable terminal 2, which is a charging target device. Wireless power feeding can be performed. That is, even a portable terminal not mounted with the wireless power feeding function can receive wireless power feeding if the portable cover accessory having the wireless power receiving function is attached to the portable terminal. In particular, in general, a power receiving device such as a portable cover accessory is developed without taking into account communication with a host or a charging control circuit of a portable terminal. Therefore, it is likely that the power receiving device cannot determine whether a battery of the portable terminal is fully charged. Therefore, even after the battery of the portable terminal is fully charged, the power receiving device cannot notify the power transmitter to stop power transmission and always receives wireless power feeding.

As shown in FIG. 2, the portable terminal 2 includes a lithium ion secondary battery (hereinafter referred to as battery) 10 and a charging control circuit 11 that performs charging control of the battery 10. Note that the battery 10 of the portable terminal 2 is not limited to the lithium ion secondary battery and may be secondary batteries of other types.

The portable cover accessory 3 includes a power receiving IC 5 and a reception coil 20. The power receiving IC 5, which is the semiconductor device in the embodiment, includes a rectifier 21, a regulator 22, a voltage detection circuit 23, a current detection circuit 24, a modulation circuit 25, an arithmetic/control circuit 26, and a memory 27.

The power transmitter 4 is connected to, for example, a household commercial power supply via an AC adapter 30. The power transmitter 4 includes a control circuit 31, a PWM circuit 32, a pre-driver circuit 33, a detector 34, a filter circuit 35, a full bridge circuit 36, and a transmission coil 37.

Alternating-current power from the commercial power supply is converted into direct-current power by the AC adapter 30 and supplied to the power transmitter 4. After being subjected to PWM control by the PWM circuit 32, the converted direct-current power is driven by the pre-driver circuit 33 and supplied to the full bridge circuit 36.

The control circuit 31 controls the PWM circuit 32 on the basis of information transmitted from the portable cover accessory 3 on a power reception side to control transmission power. More specifically, data modulated by the modulation circuit 25 of the portable cover accessory 3 is transmitted from the reception coil 20 to the transmission coil 37. The data transmitted to the power transmitter 4 is, for example, information concerning received power currently being received, information for instructing an increase or a reduction of the received power, or information for instructing a power transmission stop.

The control circuit 31 controls the PWM circuit 32 on the basis of the information concerning the received power currently being received and the information for instructing an increase or a reduction of the received power and controls the transmission power (amount) transmitted to the portable cover accessory 3. The control circuit 31 performs control for a stop of power transmission to the portable cover accessory 3 on the basis of the information for instructing the power transmission stop.

The full bridge circuit 36 converts the direct-current power into alternating-current power and supplies the alternating-current power to the transmission coil 37. Consequently, since an alternating current flows to the transmission coil 37, a magnetic flux is generated. As a result, the alternating current flows to the reception coil 20 as well. Wireless power feeding is performed.

In this way, as a system of the wireless power feeding in the wireless power feeding system 1 in the embodiment, an electromagnetic induction system, which is currently a most major system, is explained. However, the system is not limited to the electromagnetic induction system. The system may be another system such as a magnetic resonance system, an electric field coupling system, or a microwave system.

The rectifier 21 rectifies the alternating current received by the reception coil 20 and supplies the alternating current to the regulator 22. The regulator 22 includes an LDO (low drop out) regulator or a DCDC converter. The regulator 22 is a circuit that regulates electric power rectified by the rectifier 21. The regulator 22 supplies the regulated electric power to the charging control circuit 11 of the portable terminal 2. Note that the electric power rectified by the rectifier 21 may be directly supplied to the charging control circuit 11 without providing the regulator 22.

The voltage detection circuit 23 monitors and measures an output voltage from the regulator 22 and outputs a measurement result to the arithmetic/control circuit 26. The current detection circuit 24 monitors and measures an output current from the regulator 22 and outputs a measurement result to the arithmetic/control circuit 26. Note that the current detection circuit 24 may monitor and measure an electric current equivalent to the output current from the regulator 22, that is, an electric current rectified by the rectifier 21 as indicated by a broken line in FIG. 2.

The arithmetic/control circuit 26 calculates, on the basis of the measurement result of the voltage detection circuit 23 and the measurement result of the current detection circuit 24, output power outputted to the portable terminal 2 and stores the output power in the memory 27. Note that the arithmetic/control circuit 26 may also store the measurement result of the voltage detection circuit 23 and the measurement result of the current detection circuit 24 in the memory 27.

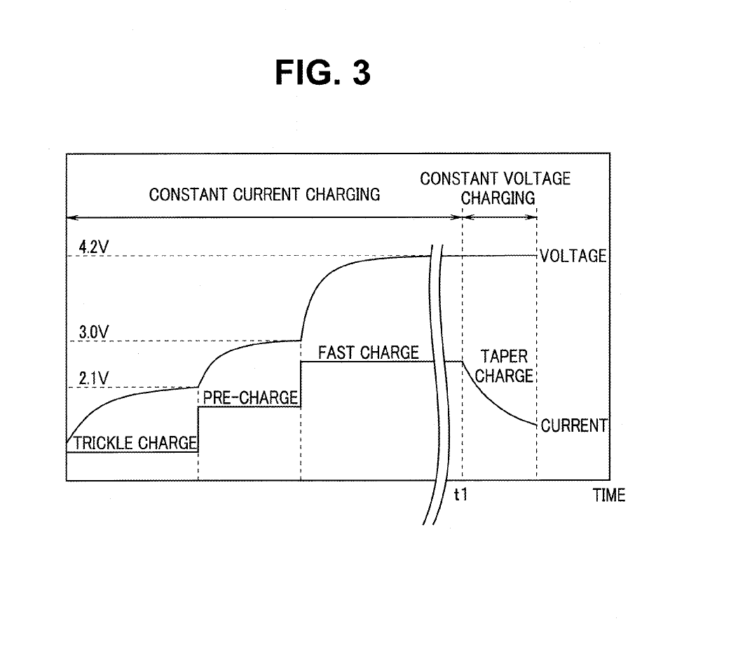

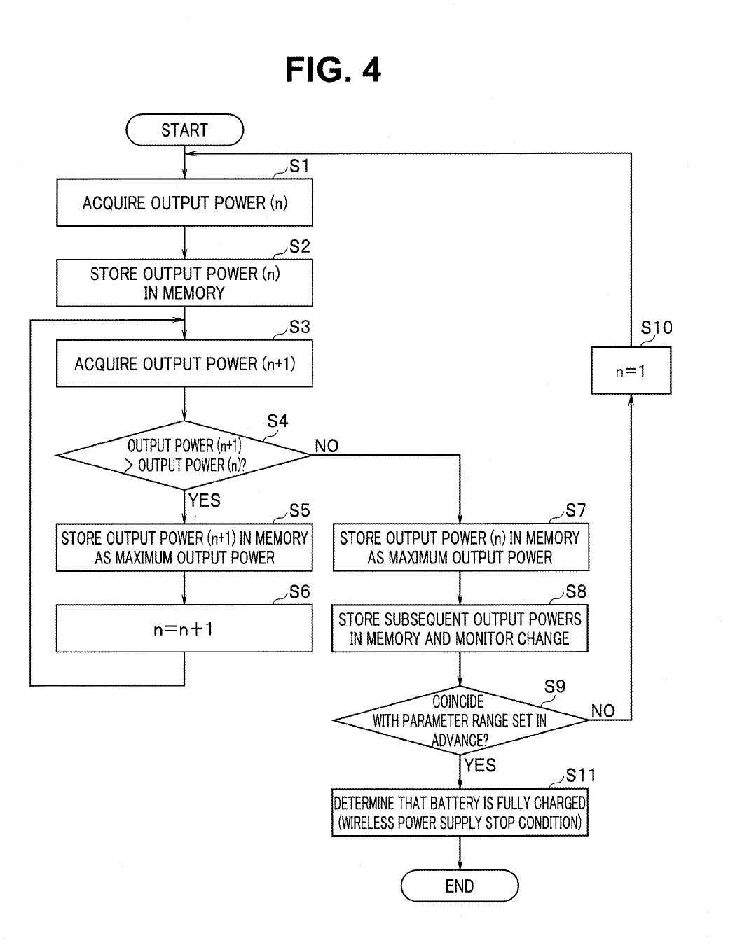

The arithmetic/control circuit 26 monitors a change in the output power or the output current outputted to the portable terminal 2 and determines whether the battery 10 of the portable terminal 2 is fully charged. When determining that the battery 10 is fully charged, the arithmetic/control circuit 26 transmits a request for a power transmission stop to the power transmitter 4. Alternatively, the arithmetic/control circuit 26 can monitor a change in the output power or the output current outputted to the portable terminal 2, calculate a charging state of the battery 10 of the portable terminal 2, and transmit the charging state of the battery 10 to the power transmitter 4. Note that a determination method for full charge is explained in detail with reference to FIGS. 3 and 4 below.

The arithmetic/control circuit 26 controls the modulation circuit 25, executes control of communication with the power transmitter 4, and executes error processing when an error occurs.

The modulation circuit 25 is a circuit that modulates data transmitted to the power transmitter 4. The modulation circuit 25 performs, for example, ASK (amplitude-shift keying) modulation. The ASK-modulated data is transmitted from the reception coil 20 to the transmission coil 37. As explained above, the data transmitted to the power transmitter 4 is, for example, the information concerning the received power currently received, the information for instructing an increase or a reduction of the received power, or the information for instructing a power transmission stop.

The information from the power receiving IC 5 is detected by the detector 34 of the power transmitter 4 and supplied to the control circuit 31 via the filter circuit 35. Consequently, the control circuit 31 performs control of the transmission power (amount) or control of a stop of the transmission power on the basis of the information transmitted from the portable cover accessory 3 on a power reception side.

A determination method for full charge of the battery 10 is explained with reference to FIG. 3. FIG. 3 is a diagram for explaining an example of a charging characteristic of the charging control circuit 11.

As shown in FIG. 3, in normal charging control, a voltage is raised by constant current charging and, when the battery 10 approaches a full charge state, the constant current charging is switched to constant voltage charging. That is, as shown in FIG. 3, the charging control circuit 11 charges the battery 10 with a constant current until time t1 and charges the battery 10 with a constant voltage after time t1.

On the other hand, as an output from the power receiving IC 5, an output current and output power change according to the charging characteristic of the charging control circuit 11 shown in FIG. 3. Note that a product of a charging current and a charging voltage shown in FIG. 3 is equivalent to the output power (power consumption and the like in a charging circuit is neglected). In the embodiment, the arithmetic/control circuit 26 calculates output power (or calculates an output current) from the regulator 22 to determine a switching point (time t2) when the constant current charging is switched from the constant current charging to the constant voltage charging. The arithmetic/control circuit 26 determines whether a change in the output power (or the output current) from the switching point (time t1) coincides with a parameter range set in advance. When the change in the output power (or the output current) coincides with the parameter range set in advance, the arithmetic/control circuit 26 determines that the battery 10 is fully charged and requests the power transmitter 4 to stop the power feeding.

As an example, more specifically, when the output power (or the output current) decreases at a predetermined decrease ratio from maximum output power (or a maximum output current), the arithmetic/control circuit 26 determines that the battery 10 is fully charged. Alternatively, when the output power (or the output current) decreases to be equal to or smaller than a predetermined threshold, the arithmetic/control circuit 26 determines that the battery 10 is fully charged. Note that, when the output power (or the output current) decreases at the predetermined decrease ratio from the maximum output power (or the maximum output current) and the output power (or the output current) decreases to be equal to or smaller than the predetermined threshold, the arithmetic/control circuit 26 may determine that the battery 10 is fully charged.

In this way, when the output power of the regulator 22 reaches a maximum, the arithmetic/control circuit 26 determines that the constant current charging is switched to the constant voltage charging. In order to determine the maximum output power with which the output power of the regulator 22 reaches a maximum, the arithmetic/control circuit 26 always calculates output power and stores data of the calculated output power in the memory 27. The arithmetic/control circuit 26 compares data of output power calculated anew and the data of the output power stored in the memory 27 to determine the maximum output current.

The arithmetic/control circuit 26 continuously stores and compares data of output power to prevent erroneous detection of the maximum output power. After a difference of compared data becomes substantially equal, when detecting that data of output power calculated anew gradually decreases, the arithmetic/control circuit 26 determines that data at a point in time when before the data of the output power calculated anew decreases is the maximum output power.

Detection processing for full charge of the power receiving IC 5 configured as explained above is explained FIG. 4 is a flowchart for explaining an example of a flow of the detection processing for the full charge of the power receiving IC 5.

First, the arithmetic/control circuit 26 acquires output power (n) outputted from the power receiving IC 5 (step S1) and stores the acquired output power (n) in the memory 27 (step S2). In this processing in step S1, the arithmetic/control circuit 26 calculates output power on the basis of an output voltage and an output current of the regulator 22 detected by the voltage detection circuit 23 and the current detection circuit 24.

Subsequently, the arithmetic/control circuit 26 acquires output power (n+1) outputted from the power receiving IC 5 (step S3) and determines whether the output power (n+1) acquired anew is larger than the output power (n) stored in the memory 27 (step S4). When determining that the output power (n+1) acquired anew is larger than the stored output power (n) (YES in step S4), the arithmetic/control circuit 26 stores the output power (n+1) acquired anew in the memory 27 as the maximum output power (step S5). The arithmetic/control circuit 26 executes n=n+1 (step S6) and returns to step S3.

On the other hand, when determining that the output power (n+1) acquired anew is not larger than the stored output power (n) (NO in step S4), the arithmetic/control circuit 26 stores the output power (n) in the memory 27 as the maximum output power (step S7), stores subsequent output power in the memory 27, and monitors a change in the output power (step S8).

Subsequently, the arithmetic/control circuit 26 determines whether the monitored change in the output power coincides with a parameter range set in advance (step S9). That is, the arithmetic/control circuit 26 determines whether the change in the output power is a set change. More specifically, the arithmetic/control circuit 26 determines whether a transition of the output power is a decrease ratio set in advance or the output power is equal to or smaller than a threshold set in advance.

Note that the charging characteristic is sometimes different depending on a type of the portable terminal 2, a type of the battery 10, or the like. Therefore, a plurality of kinds of parameters are stored in the memory 27 such that various sequences can be assumed.

When the monitored change of the output power does not coincide with the parameter range set in advance (NO in step S9), the arithmetic/control circuit 26 executes n=1 (step S10), returns to step S1, and acquires output power. For example, the output power from the power receiving IC 5 sometimes temporarily increases or decreases because of an influence of noise or the like. In such a case, since the monitored change of the output power does not coincide with the parameter range set in advance, the arithmetic/control circuit 26 returns to step S1 and continues the acquisition of output power from the power receiving IC 5.

On the other hand, when the monitored change of the output power coincides with the parameter range set in advance (YES in step S9), the arithmetic/control circuit 26 determines that the battery 10 of the portable terminal 2, which is the charging target device, is fully charged (a wireless power supply stop condition) (step S11) and ends the processing.

When determining that the battery 10 is fully charged, the arithmetic/control circuit 26 controls the modulation circuit 25 and transmits a command for instructing a power transmission stop or a command representing a charging state to the power transmitter 4. Note that the power receiving IC 5 may transmit the charging state of the battery 10 to the power transmitter 4 without transmitting the command for instructing the power transmission stop to the power transmitter 4. The power transmitter 4 may determine the power transmission stop.

Note that means for calculating the maximum output power compares the magnitude of an average value (or an addition value) of a continuous predetermined number of output powers (or output currents). Therefore, the maximum output power is not erroneously detected even if fluctuation of output power due to noise occurs. For example, when output power (n+1)+output power (n+2)+output power (n+3) is larger than output power (n)+output power (n+1)+output power (n+2), the determination in step S4 is YES.

As explained above, the power receiving IC 5 monitors the output power (or the output current) outputted from the regulator 22, which changes according to the charging state of the battery 10, to determine the full charge of the battery 10.

A conventional power receiving IC cannot issue a request for a power transmission stop to the power transmitter 4 unless the power receiving IC receives a signal indicating that the battery 10 is fully charged from the charging control circuit 11, that is, from the portable terminal 2, which is the charging target device.

On the other hand, the power receiving IC 5 in the embodiment monitors a change in output power (or output current) outputted from the power receiving IC 5 to the charging target device to determine the full charge of the battery 10. Therefore, the power receiving IC 5 alone can determine the full charge of the battery 10 and issue a request for a power transmission stop to the power transmitter 4.

Therefore, with the power receiving IC, which is the semiconductor device in the embodiment, it is possible to control transmission power from the power transmitter on the basis of information due to a charging state of the charging target device.

While certain embodiments have been described, these embodiments have been presented by way of example only, and are not intended to limit the scope of the inventions. Indeed, the novel apparatuses, methods and circuits described herein may be embodied in a variety of other forms; furthermore, various omissions, substitutions and changes in the form of the apparatuses, methods and circuits described herein may be made without departing from the spirit of the inventions. The accompanying claims and their equivalents are intended to cover such forms or modifications as would fall within the scope and spirit of the inventions.

What is claimed is:

1. A semiconductor device comprising:
an arithmetic unit configured to detect an output current outputted to a charging target device or calculate output power outputted to the charging target device; and
a determining unit configured to determine, according to the output current or the output power, whether a battery of the charging target device is fully charged.

2. The semiconductor device according to claim 1, further comprising a transmitting unit configured to transmit, when the determining unit determines that the battery is fully charged, a command for instructing a power transmission stop to a power transmitter.

3. The semiconductor device according to claim 1, wherein, after the output current or the output power reaches a maximum, when the output current or the output power continues to decrease for a predetermined period, the determining unit determines that the battery is fully charged.

4. The semiconductor device according to claim 1, wherein, after the output current or the output power reaches a maximum, when the output current or the output power decreases to be smaller than a predetermined threshold, the determining unit determines that the battery is fully charged.

5. The semiconductor device according to claim 1, wherein, after the output current or the output power reaches a maximum, when the output current or the output power continues to decrease for a predetermined period and decreases to be smaller than a predetermined threshold, the determining unit determines that the battery is fully charged.

6. The semiconductor device according to claim 1, further comprising a memory for storing the output current or the output power.

7. The semiconductor device according to claim 1, wherein the semiconductor device is included in an accessory to be attached to the charging target device.

8. The semiconductor device according to claim 7, wherein the accessory is a cover accessory that covers the charging target device.

9. The semiconductor device according to claim 7, wherein the charging target device is a portable device.

10. A semiconductor device that receives electric power transmitted from a power transmitter and controls charging of the received electric power in a battery, the semiconductor device comprising:
a rectifier configured to rectify the received electric power;
a current detection circuit configured to detect an output current corresponding to the rectified electric power; and
an arithmetic circuit configured to calculate a charging state of the battery on the basis of the output current.

11. The semiconductor device according to claim 10, further comprising:
a regulator configured to adjust a voltage of the rectified electric power; and
a voltage detection circuit configured to detect an output voltage of the regulator, wherein
the arithmetic circuit calculates the charging state of the battery on the basis of the output current and the output voltage.

12. The semiconductor device according to claim 11, wherein the current detection circuit detects an output current outputted from the rectifier or an output current outputted from the regulator.

13. The semiconductor device according to claim 10, wherein
the battery is included in a portable device, and
the semiconductor device is included in an accessory to be attached to the portable device.

14. The semiconductor device according to claim 13, wherein the accessory is a cover accessory that covers the portable device.

15. A wireless power feeding system comprising:
a charging target device including a battery; and
a semiconductor device including:
an arithmetic unit configured to detect an output current outputted to the charging target device or calculate output power outputted to the charging target device; and
a determining unit configured to determine, according to the output current or the output power, whether the battery of the charging target device is fully charged.

16. The wireless power feeding system according to claim 15, further comprising a transmitting unit configured to transmit, when the determining unit determines that the battery is fully charged, a command for instructing a power transmission stop to a power transmitter.

17. The wireless power feeding system according to claim 15, wherein, after the output current or the output power reaches a maximum, when the output current or the output power continues to decrease for a predetermined period, the determining unit determines that the battery is fully charged.

18. The wireless power feeding system according to claim 15, wherein, after the output current or the output power reaches a maximum, when the output current or the output power decreases to be smaller than a predetermined threshold, the determining unit determines that the battery is fully charged.

19. The wireless power feeding system according to claim 15, wherein, after the output current or the output power reaches a maximum, when the output current or the output power continues to decrease for a predetermined period and decreases to be smaller than a predetermined threshold, the determining unit determines that the battery is fully charged.

20. The wireless power feeding system according to claim 15, further comprising a memory for storing the output current or the output power.
